(19) United States
(12) Patent Application Publication
(10) Pub. No.: US 2015/0044473 A1
(43) Pub. Date: Feb. 12, 2015

(54) STRENGTHENED GLASS SUBSTRATE MANUFACTURING METHOD AND STRENGTHENED GLASS SUBSTRATE

(71) Applicant: Nippon Electric Glass Co., Ltd., Shiga (JP)

(72) Inventors: Takashi Murata, Shiga (JP); Takako Tojyo, Shiga (JP)

(21) Appl. No.: 14/381,665

(22) PCT Filed: Jul. 8, 2013
(86) PCT No.: PCT/JP2013/068615

§ 371 Date: Aug. 28, 2014

(30) Foreign Application Priority Data
Jul. 9, 2012 (JP) 2012-153317

(51) Int. Cl. C03C 21/00; C03B 17/06; C03C 3/083

(52) U.S. Cl. CPC C03C 21/002; C03C 3/083; C03B 17/064
USPC 428/410; 65/30.14

(57) ABSTRACT

A method of manufacturing a tempered glass substrate includes: melting glass raw materials blended so as to have a glass composition including, in terms of mass %, 40 to 71% of SiO₂, 3 to 23% of Al₂O₃, 0 to 3.5% of Li₂O, 7 to 20% of Na₂O, and 0 to 15% of K₂O; forming the resultant molten glass into a sheet shape; and performing ion exchange treatment in a KNO₃ molten salt, the KNO₃ molten salt having a controlled concentration of Na ions, to form a compressive stress layer in a surface of the glass.

### TECHNICAL FIELD

The present invention relates to a method of manufacturing a tempered glass substrate, and more particularly, to a method of manufacturing a tempered glass substrate suitable for a cover glass for a cellular phone, a digital camera, a personal digital assistant (PDA), or a solar cell, or a substrate for a touch panel display.

### BACKGROUND ART

Devices such as a cellular phone, a digital camera, a PDA, a solar cell, and a touch panel display are widely used and show a tendency of further prevalence.

Hitherto, in those applications, a resin substrate such as an acrylic substrate has been used as a protective member for protecting a display. However, owing to its low Young's modulus, the resin substrate is liable to bend when a display surface of the display is pushed with a pen, a human finger, or the like. Therefore, the resin substrate causes a display failure through its contact with an internal display in some cases. The resin substrate also involves a problem of being liable to have flaws on its surfaces, resulting in easy reduction of visibility. A solution to those problems is to use a glass substrate as the protective member. The glass substrate (cover glass) is required to, for example, (1) have a high mechanical strength, (2) have a low density and a light weight, (3) be able to be supplied at low cost in a large amount, (4) be excellent in bubble quality, (5) have a high light transmittance in a visible region, and (6) have a high Young's modulus so as not to bend easily when its surface is pushed with a pen, a finger, or the like. In particular, a glass substrate that does not satisfy the requirement (1) cannot serve as the protective member, and hence a glass substrate tempered by ion exchange treatment or the like (so-called tempered glass substrate) has been used as the protective member heretofore (see Patent Literature 1 and Non Patent Literature 1).

### CITATION LIST

### Patent Literature

[PTL 1] JP 2006-83045 A

### Non Patent Literature

[NPL 1] Tetsuro Izumitani et al., “New glass and physical properties thereof,” First edition, Management System Laboratory. Co., Ltd., Aug. 20, 1984, p. 451-498

### SUMMARY OF INVENTION

### Technical Problem

In recent years, for the purpose of reducing the thickness and cost of a touch panel display, the following manufacturing process has started to be adopted. Patterning is performed on a tempered glass substrate with an ITO film or the like, and then the tempered glass is cut. However, in the cutting of the tempered glass, its internal tensile stress value needs to be regulated within an appropriate range so that an unintended crack may not develop. To that end, attention needs to be paid so that a surface compressive stress may not become excessively high.

Meanwhile, some panel manufacturers do not cut the tempered glass. Thus, glass manufacturers need to manufacture a tempered glass having high mechanical strength and a tempered glass whose compressive stress is controlled so as to achieve an internal tensile stress value in an appropriate range. At present, the former tempered glass and the latter tempered glass use different materials. Consequently, the glass manufacturers inevitably suffer a reduction in production efficiency of tempered glass substrates. In other words, if the same material can be used for the former tempered glass and the latter tempered glass, the production efficiency of the tempered glass substrates dramatically improves.

The present invention has been made in view of the above-mentioned circumstances, and a technical object of the present invention is to devise a method of manufacturing a tempered glass substrate by which a tempered glass having high mechanical strength and a tempered glass having high cutting property can both be produced using the same material.

### Solution to Problem

The inventors of the present invention have made various studies, and as a result, have found that the technical object can be achieved by controlling the concentration of Na ions in a KNO₃ molten salt and subjecting a glass substrate to ion exchange treatment using the KNO₃ molten salt. The finding is proposed as the present invention. That is, a method of manufacturing a tempered glass substrate of the present invention comprises: melting glass raw materials blended so as to have a glass composition comprising, in terms of mass %, 40 to 71% of SiO₂, 3 to 23% of Al₂O₃, 0 to 3.5% of Li₂O, 7 to 20% of Na₂O, and 0 to 15% of K₂O; forming the resultant molten glass into a sheet shape; andperforming ion exchange treatment in a KNO₃ molten salt, the KNO₃ molten salt having a controlled concentration of Na ions, to form a compressive stress layer in a surface of the glass.

The compressive stress value and depth of layer of the compressive stress layer can be varied by adjusting the concentration of the Na ions in the KNO₃ molten salt. Consequently, a tempered glass having high mechanical strength and a tempered glass having high cutting property can both be produced using the same material.

Second, a method of manufacturing a tempered glass substrate of the present invention comprises: melting glass raw materials blended so as to have a glass composition comprising, in terms of mass %, 40 to 71% of SiO₂, 3 to 23% of Al₂O₃, 0 to 3.5% of Li₂O, 7 to 20% of Na₂O, and 0 to 15% of K₂O; forming the resultant molten glass into a sheet shape; andperforming ion exchange treatment in a KNO₃ molten salt comprising 1,000 to 50,000 ppm (by mass) of Na ions to form a compressive stress layer in a surface of the glass.

Third, a method of manufacturing a tempered glass substrate of the present invention comprises: melting glass raw materials blended so as to have a glass composition comprising, in terms of mass %, 40 to 71% of SiO₂, 3 to 23% of Al₂O₃, 0 to 3.5% of Li₂O, 7 to 20% of Na₂O, and 0 to 15% of K₂O; forming the resultant molten glass into a sheet shape; andperforming ion exchange treatment in a KNO₃ molten salt comprising one kind or two or more kinds of Na ions, Li ions, Ag ions, Ca ions, Sr ions, and Ba ions to form a compressive stress layer in a surface of the glass.

Fourth, in the method of manufacturing a tempered glass substrate of the present invention, the forming the molten glass into a sheet shape is preferably performed by a down-draw method. Fifth, in the method of manufacturing a tempered glass substrate of the present invention, the forming the molten glass into a sheet shape is preferably performed by an overflow down-draw method. Herein, the “overflow down-draw method” refers to a method comprising causing a molten glass to overflow from both sides of a heat-resistant forming trough, and subjecting the overflowing molten glasses to down-draw downward while the molten glasses are joined at the lower end of the forming trough, to thereby manufacture a glass sheet.

Sixth, a tempered glass substrate of the present invention has a compressive stress layer in a surface thereof, comprises as a glass composition, in terms of mass %, 40 to 71% of SiO₂, 3 to 23% of Al₂O₃, 0 to 3.5% of Li₂O, 7 to 20% of Na₂O, and 0 to 15% of K₂O, and is subjected to ion exchange treatment in a KNO₃ molten salt comprising Na ions.

Seventh, the tempered glass substrate of the present invention is preferably subjected to ion exchange treatment in a KNO₃ molten salt comprising 1,000 to 50,000 ppm of Na ions.

Eighth, in the tempered glass substrate of the present invention, the compressive stress layer preferably has a compressive stress value of 700 MPa or less and/or a depth of layer of 40 μm or less. Herein, the “compressive stress value” and the “depth of layer” refer to values calculated on the basis of the number of interference fringes observed when an evaluation sample is observed using a surface stress meter (for example, FSM-6000 manufactured by TOSHIBA CORPORATION) and intervals therebetween.

Ninth, the tempered glass substrate of the present invention preferably has an unpolished surface, and it is more preferred that the entire effective surfaces of both surfaces (front surface and back surface) of the tempered glass substrate be not polished. The unpolished surface is, in other words, a fire-polished surface, and thus an average surface roughness (Ra) can be reduced.

Tenth, the tempered glass substrate of the present invention preferably has a liquidus temperature of 1,200° C. or less. Herein, the “liquidus temperature” refers to a temperature at which crystals of glass are deposited after glass powder that is obtained by pulverizing a glass, passes through a standard 30-mesh sieve (sieve opening: 500 μm), and remains on a 50-mesh sieve (sieve opening: 300 μm) is placed in a platinum boat and then kept for 24 hours in a gradient heating furnace.

Eleventh, the tempered glass substrate of the present invention preferably has a liquidus viscosity of 10^{4.0} dPa·s or more. Herein, the “liquidus viscosity” refers to the viscosity of glass at the liquidus temperature. It should be noted that as the liquidus viscosity increases and the liquidus temperature reduces, denitrification resistance improves to facilitate the forming of the glass substrate.

Twelfth, the tempered glass substrate of the present invention is preferably used for a cover glass for a display.

Thirteenth, the tempered glass substrate of the present invention is preferably used for a cover glass for a solar cell.

Fourteenth, a tempered glass substrate of the present invention has a compressive stress layer in a surface thereof, comprises as a glass composition, in terms of mass %, 40 to 71% of SiO₂, 3 to 23% of Al₂O₃, 0 to 3.5% of Li₂O, 7 to 20% of Na₂O, and 0 to 15% of K₂O, and has an internal tensile stress value of 60 MPa or less. Herein, the “internal tensile stress value” is calculated from the following equation.

Internal tensile stress value=(compressive stress value×depth of layer)/(substrate thickness−depth of layer×2)

### DESCRIPTION OF EMBODIMENTS

The reasons why the glass composition is limited to the above-mentioned range in the method of manufacturing a tempered glass substrate of the present invention are described below. It should be noted that the expression “%” refers to “mass %” in the following description of the content range of each component unless otherwise specified.

SiO₂ is a component that forms a network of a glass. The content of SiO₂ is from 40 to 71%, preferably from 40 to 70%, more preferably from 40 to 63%, more preferably from 45 to 63%, more preferably from 50 to 59%, particularly preferably from 55 to 58.5%. When the content of SiO₂ is too large, meltability and formability lower, and the thermal expansion coefficient becomes too low, with the result that it becomes difficult to match the thermal expansion coefficient with those of peripheral materials. On the other hand, when the content of SiO₂ is too small, vitrification does not occur easily. Further, the thermal expansion coefficient becomes too high, and thermal shock resistance is liable to lower.

Al₂O₃ is a component that increases ion exchange performance, and has also an effect of increasing a strain point and a Young's modulus. The content of Al₂O₃ is from 3 to 23%. When the content of Al₂O₃ is too large, a devitrified crystal is liable to deposit in the glass and it becomes difficult to form the glass by an overflow down-draw method. Further, the thermal expansion coefficient becomes too low, with the result that it becomes difficult to match the thermal expansion coefficient with those of peripheral materials. In addition, the viscosity at high temperature rises, and the meltability is liable to lower. When the content of Al₂O₃ is too small, sufficient ion exchange performance is not exhibited in some cases. From the above-mentioned viewpoints, the upper limit of the content of Al₂O₃ is preferably 21% or less, more preferably 20% or less, more preferably 19% or less, more preferably 18% or less, more preferably 17% or less, particularly preferably 16.5% or less. Further, the lower limit of the content of Al₂O₃ is preferably 7.5% or more, more preferably 8.5% or more, more preferably 9% or more, more preferably 10% or more, more preferably 12% or more, more preferably 13% or more, more preferably 14% or more, more preferably 15% or more, particularly preferably 16% or more.

Li₂O is an ion exchange component, and is also a component that lowers the viscosity at high temperature to increase the meltability and the formability. Further, Li₂O is a component that increases the Young's modulus. Further, Li₂O has a high effect of increasing the compressive stress value among alkali metal oxides. However, when the content of Li₂O is too large, the liquidus viscosity lowers and the glass is liable to be devitrified. Further, the thermal expansion coefficient becomes too high, and the thermal shock resistance lowers, with the result that it becomes difficult to match the thermal expansion coefficient with those of peripheral materials. Further, when the viscosity at low temperature excessively lowers and stress relaxation easily occurs, the compressive stress value may lower contrarily. Therefore, the content of Li₂O is from 0 to 3.5%, preferably from 0 to 2%, more preferably from 0 to 1%, more preferably from 0 to 0.5%, still more preferably from 0 to 0.1%. It is most preferred that the content of Li₂O be substantially zero, that is, be limited to less than 0.01%.

Na₂O is an ion exchange component, and is also a component that lowers the viscosity at high temperature to increase the meltability and the formability. Further, Na₂O is also a component that improves the devitrification resistance. The content of Na₂O is from 7 to 20%, preferably from 10 to 20%, more preferably from 10 to 19%, more preferably from 12 to 19%, more preferably from 12 to 17%, more preferably from 13 to 17%, particularly preferably from 14 to 17%. When the content of Na₂O is too large, the thermal expansion coefficient becomes too high, and the thermal shock resistance lowers, with the result that it becomes difficult to match the thermal expansion coefficient with those of peripheral materials. Further, there are tendencies that the strain point excessively lowers, and the glass composition loses its component balance, with the result that the devitrification resistance lowers contrarily. On the other hand, when the content of Na₂O is small, the meltability lowers, the thermal expansion coefficient becomes too low, and the ion exchange performance is liable to lower.

K₂O is a component that has an effect of promoting ion exchange, and has a high effect of increasing a depth of layer among alkali metal oxides. Further, K₂O is a component that lowers the viscosity at high temperature to increase the meltability and the formability. K₂O is also a component that improves the devitrification resistance. The content of K₂O is preferably from 0 to 15%. When the content of K₂O is too large, the thermal expansion coefficient becomes high, and the thermal shock resistance lowers, with the result that it becomes difficult to match the thermal expansion coefficient with those of peripheral materials. Further, there are tendencies that the strain point excessively lowers, and the glass composition loses its component balance, with the result that the devitrification resistance lowers contrarily. Therefore, the upper limit of the content of K₂O is preferably 12% or less, more preferably 10% or less, more preferably 8% or less, more preferably 6% or less, more preferably 5% or less, more preferably 4% or less, more preferably 3% or less, particularly preferably 2% or less.

When the total content of alkali metal oxides R₂O (R represents one or more kinds selected from Li, Na, and K) is too large, the glass is liable to be devitrified. In addition, the thermal expansion coefficient becomes too high, and the thermal shock resistance lowers, with the result that it becomes difficult to match the thermal expansion coefficient with those of peripheral materials. Further, when the total content of R₂O is too large, the strain point excessively lowers, and a high compressive stress value is not obtained in some cases. Further, the viscosity around the liquidus temperature lowers, and it becomes difficult to secure a high liquidus viscosity in some cases. Therefore, the total content of R₂O is preferably 22% or less, more preferably 20% or less, particularly preferably 19% or less. On the other hand, when the total content of R₂O is too small, the ion exchange performance and the meltability lower in some cases. Therefore, the total content of R₂O is preferably 8% or more, more preferably 10% or more, more preferably 13% or more, particularly preferably 15% or more.

The value of (Na₂O+K₂O)/Al₂O₃ is desirably regulated within the range of preferably from 0.7 to 2, more preferably from 0.8 to 1.6, still more preferably from 0.9 to 1.6, particularly preferably from 1 to 1.6, most preferably from 1.2 to 1.6. When the value is more than 2, the viscosity at low temperature is liable to lower excessively to lower the ion exchange performance, the Young's modulus is liable to lower, and the thermal expansion coefficient is liable to increase excessively to lower the thermal shock resistance. There is also a tendency that the glass composition loses its balance, with the result that the devitrification resistance lowers. On the other hand, when the value is less than 0.7, the meltability and the devitrification resistance are liable to lower.

Amass ratio K₂O/Na₂O preferably falls within the range of from 0 to 2. The magnitude of the compressive stress value and the depth of layer can be changed by changing the mass ratio K₂O/Na₂O When it is desired to set the compressive stress value high, the mass ratio is preferably adjusted within the range of from 0 to 0.5, particularly preferably from 0 to 0.3 or from 0 to 0.2. Meanwhile, when it is desired to additionally increase the depth of layer or form a deep stress in a short period of time, the mass ratio is preferably adjusted within the range of from 0.3 to 2, particularly preferably from 0.5 to 2, from 1 to 2, or from 1.2 to 2, even more preferably from 1.5 to 2. In this case, the reason why the upper limit of the mass ratio is set to 2 is as follows: when the value is more than 2, the glass composition loses its balance, with the result that the devitrification resistance lowers.

In addition to the components described above, other components may be added as long as the physical properties of the glass are not impaired to a great extent.

For example, alkaline earth metal oxides R′O (R′ represents one or more kinds selected from Mg, Ca, Sr, and Ba) are components that may be added for various purposes. However, when the total content of R′O is high, the density and the thermal expansion coefficient become high, and the devitrification resistance lowers. In addition, the ion exchange performance tends to lower. Therefore, the total content of R′O is preferably from 0 to 9.9%, more preferably from 0 to 8%, more preferably from 0 to 6%, particularly preferably from 0 to 5%.

MgO is a component that lowers the viscosity at high temperature to increase the meltability and the formability, or to increase the strain point and the Young's modulus, and has a high effect of improving the ion exchange performance among alkaline earth metal oxides. The content of MgO is preferably from 0 to 6%. However, when the content of MgO is high, the density and the thermal expansion coefficient increase, and the glass is liable to be devitrified. Thus, the content of MgO is preferably 4% or less, more preferably 3% or less, more preferably 2% or less, particularly preferably 1.5% or less.

CaO is a component that lowers the viscosity at high temperature to increase the meltability and the formability, or to increase the strain point and the Young's modulus, and has a high effect of improving the ion exchange performance among alkaline earth metal oxides. The content of CaO is preferably from 0 to 6%. However, when the content of CaO is high, the density and the thermal expansion coefficient increase, and the glass is liable to be devitrified. In addition, the ion exchange performance lowers in some cases. Therefore, the content of CaO is preferably 4% or less, particularly preferably 3% or less.

SrO and BaO are components that lower the viscosity at high temperature to increase the meltability and the formability, or to increase the strain point and the Young's modulus. The content of each of SrO and BaO is preferably from 0 to 3%. When the content of each of SrO and BaO is high, the ion exchange performance tends to lower. Further, the density and the thermal expansion coefficient increase, and the glass is liable to be devitrified. The content of SrO is preferably 2% or less, more preferably 1.5% or less, more preferably 1% or less, more preferably 0.5% or less, more preferably 0.2% or less, particularly preferably 0.1% or less. In addition, the content of BaO is preferably 2.5% or less, more preferably 2% or less, more preferably 1% or less, more preferably 0.8% or less, more preferably 0.5% or less, more preferably 0.2% or less, particularly preferably 0.1% or less.

ZnO is a component that enhances the ion exchange performance of glass, and has a high effect of increasing the compressive stress value, in particular. Further, ZnO is a component that has an effect of reducing the viscosity at high temperature without reducing the viscosity at low temperature. The content of ZnO may be from 0 to 8%. However, when the content of ZnO is high, the glass undergoes phase separation, the denitrification resistance lowers, and the density increases. Thus, the content of ZnO is preferably 6% or less, more preferably 4% or less, particularly preferably 3% or less.

The ion exchange performance can be more effectively enhanced by controlling the total content of SrO+BaO within the range of from 0 to 5%. That is, SrO and BaO each have an action of inhibiting an ion exchange reaction as described above, and hence the incorporation of large amounts of these components is disadvantageous for obtaining a tempered glass having high mechanical strength. The total content of SrO+BaO falls within the range of preferably from 0 to 3%, more preferably from 0 to 2.5%, more preferably from 0 to 2%, more preferably from 0 to 1%, more preferably from 0 to 0.2%, particularly preferably from 0 to 0.1%.

When a value obtained by dividing the total content of R′O by the total content of R₂O increases, there appears a tendency that the devitrification resistance lowers. Thus, the value of R′O/R₂O in terms of a mass ratio is preferably 0.5 or less, more preferably 0.4 or less, particularly preferably 0.3 or less.

SnO₂ has an effect of enhancing ion exchange performance, in particular, the compressive stress value. Thus, the content of SnO₂ is preferably from 0 to 3%, more preferably from 0.01 to 3%, more preferably from 0.01 to 1.5%, particularly preferably from 0.1 to 1%. When the content of SnO₂ is high, there is a tendency that devitrification due to SnO₂ is liable to occur and the glass is liable to be colored.

ZrO₂ has effects of remarkably improving the ion exchange performance and simultaneously, increasing the Young's modulus and the strain point, and lowering the viscosity at high temperature. Further, ZrO₂ has an effect of increasing the viscosity around the liquidus viscosity. Therefore, by inclusion of a given amount of ZrO₂, the ion exchange performance and the liquidus viscosity can be improved simultaneously. However, when the content of ZrO₂ is too large, the devitrification resistance remarkably lowers in some cases. Thus, the content of ZrO₂ is preferably from 0 to 10%, more preferably from 0.001 to 10%, more preferably from 0.1 to 9%, more preferably from 0.5 to 7%, more preferably from 1 to 5%, particularly preferably from 2.5 to 5%. It should be noted that when it is desired to suppress the content of ZrO₂ as much as possible from the viewpoint of the devitrification resistance, the content of ZrO₂ is preferably regulated to less than 0.1%.

B₂O₃ is a component that has effects of lowering the liquidus temperature, the viscosity at high temperature, and the density and has a high effect of improving the ion exchange performance, in particular, the compressive stress value, and hence may be comprised together with the above-mentioned components. However, when the content of B₂O₃ is too large, there are risks in that weathering occurs on the surface by ion exchange treatment, the water resistance lowers, and the liquidus viscosity lowers. Further, the depth of layer tends to lower. Therefore, the content of B₂O₃ is preferably from 0 to 6%, more preferably from 0 to 4%, particularly preferably from 0 to 3%.

TiO₂ is a component that has an effect of improving the ion exchange performance. Further, TiO₂ has an effect of lowering the viscosity at high temperature. However, when the content of TiO₂ is too large, the glass is liable to be colored, the devitrification resistance is liable to lower, and the density is liable to increase. Particularly in the case of using the glass as a cover glass for a display, if the content of TiO₂ is high, the transmittance is liable to change when the melting atmosphere or raw materials are altered. Therefore, in a process for bonding a tempered glass substrate to a device by utilizing light with a UV-curable resin or the like, ultraviolet irradiation conditions are liable to vary and stable production becomes difficult. Therefore, the content of TiO₂ is preferably 10% or less, more preferably 8% or less, more preferably 6% or less, more preferably 5% or less, more preferably 4% or less, more preferably 2% or less, more preferably 0.7% or less, more preferably 0.5% or less, more preferably 0.1% or less, particularly preferably 0.01% or less.

In the present invention, ZrO₂ and TiO₂ are preferably comprised within the above-mentioned ranges from the viewpoint of improving the ion exchange performance, and reagents may be used as a TiO₂ source and a ZrO₂ source, or ZrO₂ and TiO₂ to be comprised may derive from impurities comprised in raw materials or the like.

From the viewpoint of achieving both the denitrification resistance and high ion exchange performance, the content of Al₂O₃+ZrO₂ is preferably specified as described below. When the content of Al₂O₃+ZrO₂ is preferably more than 12%, more preferably 13% or more, more preferably 15% or more, more preferably 17% or more, more preferably 18% or more, particularly preferably 19% or more, the ion exchange performance can be more effectively enhanced. However, when the content of Al₂O₃+ZrO₂ is excessively high, the denitrification resistance lowers excessively. Thus, the content of Al₂O₃+ZrO₂ is preferably 28% or less, more preferably 25% or less, more preferably 23% or less, more preferably 22% or less, particularly preferably 21% or less.

P₂O₅ is a component that enhances the ion exchange performance, and in particular, has a high effect of increasing a depth of layer. Thus, the content of P₂O₅ may be from 0 to 8%. However, when the content of P₂O₅ is high, the glass manifests phase separation, and the water resistance and the devitrification resistance are liable to lower. Thus, the content of P₂O₅ is preferably 5% or less, more preferably 4% or less, more preferably 3% or less, particularly preferably 2% or less.

As the fining agent, one kind or two or more kinds of As₂O₃, Sb₂O₃, CeO₂, F, SO₃, and Cl may be contained in an amount of from 0.001 to 3%. The use of As₂O₃ and Sb₂O₃ is preferably avoided as much as possible with a view to environmental friendliness. Thus, the content of each of As₂O₃ and Sb₂O₃ is limited to preferably less than 0.1%, more preferably less than 0.01%, and is desirably substantially zero. In addition, CeO₂ is a component that lowers the transmittance. Thus, the content of CeO₂ is limited to less than 0.1%, preferably less than 0.01%. In addition, F may lower the viscosity at low temperature and lower the compressive stress value. Thus, the content of F is limited to less than 0.1%, preferably less than 0.01%.

Rare earth oxides such as Nb₂O₅ and La₂O₃ are components that increase the Young's modulus. However, the cost of the raw material itself is high, and when the rare earth oxides are contained in large amounts, the devitrification resistance is liable to lower. Therefore, the content of the rare earth oxides is preferably 3% or less, more preferably 2% or less, more preferably 1% or less, more preferably 0.5% or less, particularly preferably 0.1% or less.

Transition metal elements such as Co and Ni are components that cause intense coloration of a glass. In particular, in the case of using the transition metal elements in a touch panel display application, when the content of the transition metal elements is high, the transmittance of a tempered glass substrate lowers and the visibility of a tough panel display is impaired. The use amount of raw materials or cullet is adjusted so that the content of the transition metal elements is desirably 0.5% or less, more desirably 0.1% or less, particularly desirably 0.05% or less.

In addition, the use of substances such as Pb and Bi is preferably avoided as much as possible with a view to environmental friendliness, and the content of each of such substances is preferably controlled to less than 0.1%.

In the tempered glass substrate of the present invention, the suitable content range of each component can be appropriately selected to attain a preferred glass composition range. Specific examples thereof are shown below.

(1) Glass composition comprising, in terms of mass %, 40 to 71% of SiO₂, 7.5 to 23% of Al₂O₃, 0 to 2% of Li₂O, 10 to 19% of Na₂O, 0 to 15% of K₂O, 0 to 6% of MgO, 0 to 6% of CaO, 0 to 3% of SrO, 0 to 3% of BaO, 0 to 8% of ZnO, and 0.01 to 3% of SnO₂.

(2) Glass composition comprising, in terms of mass %, 40 to 71% of SiO₂, 7.5 to 23% of Al₂O₃, 0 to 2% of Li₂O, 10 to 19% of Na₂O, 0 to 15% of K₂O, 0 to 6% of MgO, 0 to 6% of CaO, 0 to 3% of SrO, 0 to 3% of BaO, 0 to 8% of ZnO, 0.01 to 3% of SnO₂, and 0.001 to 10% of ZrO₂.

(3) Glass composition comprising, in terms of mass %, 40 to 71% of SiO₂, 8.5 to 23% of Al₂O₃, 0 to 1% of Li₂O, 10 to 19% of Na₂O, 0 to 10% of K₂O, 0 to 6% of MgO, 0 to 6% of CaO, 0 to 3% of SrO, 0 to 3% of BaO, 0 to 8% of ZnO, and 0.01 to 3% of SnO₂.

(4) Glass composition comprising, in terms of mass %, 40 to 71% of SiO₂, 8.5 to 23% of Al₂O₃, 0 to 1% of Li₂O, 10 to 19% of Na₂O, 0 to 10% of K₂O, 0 to 6% of MgO, 0 to 6% of CaO, 0 to 3% of SrO, 0 to 3% of BaO, 0 to 8% of ZnO, 0.01 to 3% of SnO₂, and 0.001 to 10% of ZrO₂.

(5) Glass composition comprising, in terms of mass %, 40 to 71% of SiO₂, 9 to 19% of Al₂O₃, 0 to 6% of B₂O₃, 0 to 2% of Li₂O, 10 to 19% of Na₂O, 0 to 15% of K₂O, 0 to 6% of MgO, 0 to 6% of CaO, 0 to 3% of SrO, 0 to 3% of BaO, 0 to 6% of ZnO, 0.001 to 10% of ZrO₂, and 0.1 to 1% of SnO₂, and being substantially free of As₂O₃ and Sb₂O₃.

(6) Glass composition comprising, in terms of mass %, 40 to 71% of SiO₂, 9 to 18% of Al₂O₃, 0 to 4% of B₂O₃, 0 to 2% of Li₂O, 11 to 17% of Na₂O, 0 to 6% of K₂O, 0 to 6% of MgO, 0 to 6% of CaO, 0 to 3% of SrO, 0 to 3% of BaO, 0 to 6% of ZnO, 0.1 to 1% of SnO₂, and 0.001 to 10% of ZrO₂, and being substantially free of As₂O₃ and Sb₂O₃.

(7) Glass composition comprising, in terms of mass %, 40 to 63% of SiO₂, 9 to 17.5% of Al₂O₃, 0 to 3% of B₂O₃, 0 to 0.1% of Li₂O, 10 to 17% of Na₂O, 0 to 7% of K₂O, 0 to 5% of MgO, 0 to 4% of CaO, 0 to 3% of SrO+BaO, and 0.01 to 2% of SnO₂, being substantially free of As₂O₃ and Sb₂O₃, and having values of (Na₂O+K₂O)/Al₂O₃ and K₂O/Na₂O in terms of a mass ratio of from 0.9 to 1.6 and from 0 to 0.4, respectively.

(8) Glass composition comprising, in terms of mass %, 40 to 71% of SiO₂, 3 to 21% of Al₂O₃, 0 to 2% of Li₂O, 10 to 20% of Na₂O, 0 to 9% of K₂O, 0 to 5% of MgO, 0 to 0.5% of TiO₂, and 0.001 to 3% of SnO₂.

(9) Glass composition comprising, in terms of mass %, 40 to 71% of SiO₂, 8 to 21% of Al₂O₃, 0 to 2% of Li₂O, 10 to 20% of Na₂O, 0 to 9% of K₂O, 0 to 5% of MgO, 0 to 0.5% of TiO₂, and 0.01 to 3% of SnO₂, and being substantially free of As₂O₃ and Sb₂O₃.

(10) Glass composition comprising, in terms of mass %, 40 to 65% of SiO₂, 8.5 to 21% of Al₂O₃, 0 to 1% of Li₂O, 10 to 20% of Na₂O, 0 to 9% of K₂O, 0 to 5% of MgO, 0 to 0.5% of TiO₂, and 0.01 to 3% of SnO₂, having a value of (Na₂O+K₂O) /Al₂O₃ in terms of a mass ratio of from 0.7 to 2, and being substantially free of As₂O₃, Sb₂O₃, and F.

(11) Glass composition comprising, in terms of mass %, 40 to 65% of SiO₂, 8.5 to 21% of Al₂O₃, 0 to 1% of Li₂O, 10 to 20% of Na₂O, 0 to 9% of K₂O, 0 to 5% of MgO, 0 to 0.5% of TiO₂, 0.01 to 3% of SnO₂, and 0 to 8% of MgO+CaO+SrO+BaO, having a value of (Na₂O+K₂O) /Al₂O₃ in term of a mass ratio of from 0.9 to 1.7, and being substantially free of As₂O₃, Sb₂O₃, and F.

(12) Glass composition comprising, in terms of mass %, 40 to 63% of SiO₂, 9 to 19% of Al₂O₃, 0 to 3% of B₂O₃, 0 to 1% of Li₂O, 10 to 20% of Na₂O, 0 to 9% of K₂O, 0 to 5% of MgO, 0 to 0.1% of TiO₂, 0.01 to 3% of SnO₂, 0.001 to 10% of ZrO₂, and 0 to 8% of MgO+CaO+SrO+BaO, having a value of (Na₂O+K₂O)/Al₂O₃ in term of a mass ratio of from 1.2 to 1.6, and being substantially free of As₂O₃, Sb₂O₃, and F.

(13) Glass composition comprising, in terms of mass %, 40 to 63% of SiO₂, 9 to 17.5% of Al₂O₃, 0 to 3% of B₂O₃, 0 to 1% of Li₂O, 10 to 20% of Na₂O, 0 to 9% of K₂O, 0 to 5% of MgO, 0 to 0.1% of TiO₂, 0.01 to 3% of SnO₂, 0.1 to 8% of ZrO₂, and 0 to 8% of MgO+CaO+SrO+BaO, having a value of (Na₂O+K₂O)/Al₂O₃ in term of a mass ratio of from 1.2 to 1.6, and being substantially free of As₂O₃, Sb₂O₃, and F.

(14) Glass composition comprising, in terms of mass %, 40 to 59% of SiO₂, 10 to 15% of Al₂O₃, 0 to 3% of B₂O₃, 0 to 0.1% Li₂O, 10 to 20% of Na₂O, 0 to 7% of K₂O, 0 to 5% of MgO, 0 to 0.1% of TiO₂, 0.01 to 3% of SnO₂, 1 to 8% of ZrO₂, and 0 to 8% of MgO+CaO+SrO+BaO, having a value of (Na₂O+K₂O)/Al₂O₃ in term of a mass ratio of from 1.2 to 1.6, and being substantially free of As₂O₃, Sb₂O₃, and F.

In the method of manufacturing a tempered glass substrate of the present invention, from the viewpoint of manufacturing efficiency, it is preferred that glass raw materials blended so as to have the above-mentioned glass composition be loaded into a continuous melting furnace, heated and melted at from 1,500 to 1,600° C., and fined, and then the molten glass be supplied to a forming apparatus and formed into a sheet shape, followed by annealing.

An overflow down-draw method is preferably adopted as a method for the forming of the molten glass into a sheet shape. When the glass substrate is formed by the overflow down-draw method, it is possible to manufacture a glass substrate having satisfactory surface quality by virtue of the fact that the effective region of its surface is unpolished. This is because in the case of the overflow down-draw method, a surface that is to serve as the surface of the glass substrate is formed in a state of a free surface without being brought into contact with a trough-shaped refractory, and hence a glass substrate having satisfactory surface quality in an unpolished state can be formed. The structure and material of the trough-shaped structure are not particularly limited as long as quality that allows use as a glass substrate can be achieved by bringing the dimensions and surface precision of the glass substrate into desired states. In addition, a force for down-drawing the molten glass downward may be applied by any method. The tempered glass of the present invention is excellent in denitrification resistance and has viscosity characteristics suitable for forming, and hence can be formed by the overflow down-draw method with good precision. It should be noted that the glass substrate can be formed by the overflow down-draw method when the liquidus temperature is 1,200° C. or less and the liquidus viscosity is 10^{4.0} dPa·s or more.

It should be noted that when high surface quality is not required, a method other than the overflow down-draw method may be adopted. For example, a forming method such as a down-draw method (such as a slot down method or a re-draw method), a float method, a roll-out method, or a press method may be adopted. For example, when the glass substrate is formed by the press method, a small-size glass substrate can be efficiently manufactured.

The method of manufacturing a tempered glass substrate of the present invention comprises performing ion exchange treatment to form a compressive stress layer in a surface. The ion exchange treatment is a method comprising introducing alkali ions each having a large ion radius into the surface of the glass substrate by ion exchange at a temperature equal to or lower than the strain point of the glass substrate. When the compressive stress layer is formed by the ion exchange treatment, even when the thickness of the glass substrate is small, the compressive stress layer can be satisfactorily formed, and desired mechanical strength can be obtained. Further, the tempered glass substrate tempered by the ion exchange treatment does not easily break as a tempered glass substrate tempered by a physical tempering method such as an air cooling tempering method does.

The resultant glass substrate is subjected to ion exchange treatment by being immersed in a KNO₃ molten salt having a controlled concentration of Na ions to form a compressive stress layer in a glass surface. For example, when it is desired to enhance the mechanical strength as much as possible, it is recommended to reduce the concentration of the Na ions to, for example, 3,000 ppm or less, in particular, less than 1,000 ppm, and when it is desired to enhance cutting property, it is recommended to increase the concentration of the Na ions to, for example, 1,000 ppm or more, 3,000 ppm or more, or 5,000 ppm or more, in particular, 8,000 ppm or more . The ion exchange treatment maybe performed by, for example, immersing the glass substrate in a KNO₃ molten salt at from 400 to 550° C. for from 1 to 8 hours. Optimum conditions for the ion exchange treatment may be selected in consideration of, for example, the viscosity characteristics, applications, thickness, and internal tensile stress of the glass.

In the method of manufacturing a tempered glass substrate of the present invention, it is preferred that the ion exchange treatment be performed using a KNO₃ molten salt comprising Na ions. The concentration of the Na ions is preferably 1,000 ppm or more, more preferably 3,000 ppm or more, more preferably 5,000 ppm or more, more preferably 8,000 ppm or more, more preferably 9,000 ppm or more, more preferably 10,000 ppm or more, particularly preferably 12,000 ppm or more. When the concentration of the Na ions is less than 1,000 ppm, a change in the concentration of the Na ions significantly changes the compressive stress value, with the result that it is difficult to stably produce the tempered glass. On the other hand, when the concentration of the Na ions is more than 50,000 ppm, a tempering characteristic lowers excessively, and hence the concentration of the Na ions is regulated to preferably 50,000 ppm or less, more preferably 45,000 ppm or less, more preferably 40,000 ppm or less, more preferably 35,000 ppm or less, particularly preferably 30,000 ppm or less. It should be noted that the concentration of the Na ions can be adjusted by, for example, adding a small amount of NaNO₃ to KNO₃.

In the method of manufacturing a tempered glass substrate of the present invention, it is also preferred that the ion exchange treatment be performed using a KNO₃ molten salt comprising one kind or two or more kinds of Li ions, Ag ions, Ca ions, Sr ions, and Ba ions. With this, a similar effect to that of the KNO₃ molten salt comprising Na ions can be provided.

The lower limit of the concentration of the Li ions is preferably 1 ppm or more, more preferably 3 ppm or more, more preferably 5 ppm or more, more preferably 10 ppm or more, particularly preferably 50 ppm or more. The upper limit thereof is preferably 1,000 ppm or less, more preferably 800 ppm or less, more preferably 600 ppm or less, particularly preferably 400 ppm or less.

The concentration of each of the Ag ions, the Ca ions, the Sr ions, and the Ba ions is preferably 1,000 ppm or more, more preferably 3,000 ppm or more, more preferably 5,000 ppm or more, more preferably 8,000 ppm or more, more preferably 9,000 ppm or more, more preferably 10,000 ppm or more, more preferably 12,000 ppm or more, particularly preferably 15,000 ppm or more. When each ion concentration is less than 1,000 ppm, a change in each ion concentration significantly changes the compressive stress value, with the result that it is difficult to stably produce the tempered glass. On the other hand, when each ion concentration is more than 50,000 ppm, the tempering characteristic lowers excessively, and hence each ion concentration is regulated to preferably 50,000 ppm or less, more preferably 45,000 ppm or less, more preferably 40,000 ppm or less, more preferably 35,000 ppm or less, particularly preferably 30,000 ppm or less. It should be noted that the concentrations of the Li ions, the Ag ions, the Ca ions, the Sr ions, and the Ba ions can each be adjusted by, for example, adding a nitric acid salt of the corresponding component to KNO₃. In addition, when it is desired to enhance the mechanical strength of the tempered glass substrate as much as possible, each ion concentration may be less than 1,000 ppm.

When it is desired to enhance the mechanical strength of the tempered glass as much as possible, it is recommended to adjust the compressive stress value of the compressive stress layer to preferably 600 MPa or more, more preferably 700 MPa or more, more preferably 800 MPa or more, particularly preferably 900 MPa or more. As the compressive stress value increases, the mechanical strength of the tempered glass substrate is enhanced. Meanwhile, when it is desired to enhance the cutting property of the tempered glass, it is recommended to adjust the compressive stress value of the compressive stress layer to preferably 700 MPa or less, more preferably 650 MPa or less, more preferably 600 MPa or less, particularly preferably 550 MPa or less, and adjust the lower limit value thereof to preferably 300 MPa or more, more preferably 350 MPa or more, particularly preferably 400 MPa or more.

The compressive stress value may be increased by increasing the content of Al₂O₃, TiO₂, ZrO₂, MgO, ZnO, or SnO₂ in the glass composition, or reducing the concentration of the Na ions or the like in the KNO₃ molten salt or the content of SrO or BaO in the glass composition. The compressive stress value may also be increased by shortening an ion exchange time or reducing an ion exchange temperature. The depth of layer is preferably 10 μm or more, more preferably 15 μm or more, more preferably 20 μm or more, particularly preferably 30 μm or more. As the depth of layer increases, the tempered glass substrate becomes less liable to be cracked even when the tempered glass substrate has a deep flaw. Meanwhile, in the case where the tempered glass is cut, from the viewpoint of the internal tensile stress, the depth of layer is preferably 50 μm or less, more preferably 45 μm or less, more preferably 40 μm or less, more preferably 35 μm or less, more preferably 30 μm or less, more preferably 25 μm or less, particularly preferably 20 μm or less. In the case where the tempered glass is not cut, the depth of layer is preferably 100 μm or less, more preferably 80 μm or less, particularly preferably 60 μm or less. It should be noted that the depth of layer may be increased by increasing the content of K₂O, P₂O₅, TiO₂, or ZrO₂ in the glass composition, or reducing the concentration of the Na ions or the like in the KNO₃ molten salt or the content of SrO or BaO in the glass composition. The depth of layer may also be increased by lengthening the ion exchange time or increasing the ion exchange temperature.

The internal tensile stress value is preferably 40 MPa or less, more preferably 35 MPa or less, more preferably 30 MPa or less, more preferably 25 MPa or less, particularly preferably 20 MPa or less. In the cutting of the tempered glass, the tempered glass becomes less liable to break as the internal tensile stress value becomes smaller. However, when the internal tensile stress value is extremely small, the compressive stress value and the depth of layer reduce. Thus, the internal tensile stress value is preferably 1 MPa or more, more preferably 10 MPa or more, particularly preferably 15 MPa or more.

The tempered glass substrate of the present invention is a tempered glass substrate having a compressive stress layer in a surface thereof, comprising as a glass composition, in terms of mass %, 40 to 71% of SiO₂, 3 to 23% of Al₂O₃, 0 to 3.5% of Li₂O, 7 to 20% of Na₂O, and 0 to 15% of K₂O, and being subjected to ion exchange treatment in a KNO₃ molten salt having a controlled concentration of Na ions. Technical features (suitable component ranges, concentration of Na ions, compressive stress value, and the like) of the tempered glass substrate of the present invention overlap the technical features of the method of manufacturing a tempered glass substrate of the present invention. In other words, the technical features (suitable component ranges, concentration of Na ions, compressive stress value, and the like) of the method of manufacturing a tempered glass substrate of the present invention overlap the technical features of the tempered glass substrate of the present invention.

The tempered glass substrate of the present invention has a thickness of preferably 1.0 mm or less, more preferably 0.8 mm or less, more preferably 0.7 mm or less, more preferably 0.5 mm or less, particularly preferably 0.4 mm or less. As the thickness reduces, the weight of the tempered glass substrate can be reduced. It should be noted that when the tempered glass substrate is formed by an overflow down-draw method, a reduction in the thickness of the glass substrate and an increase in its smoothness can be achieved without polishing.

The tempered glass substrate of the present invention preferably has an unpolished surface, and the unpolished surface has an average surface roughness (Ra) of preferably 10 Å or less, more preferably 5 Å or less, still more preferably 4 Å or less, particularly preferably 3 Å or less, most preferably 2 Å or less. It should be noted that the average surface roughness (Ra) may be measured by a method in conformity with SEMI D7-94 “FPD Glass Substrate Surface Roughness Measurement Method.” A glass substrate originally has extremely high theoretical strength, but often breaks even under a stress far lower than the theoretical strength. This is because a small flaw called a Griffith flaw is generated in the surface of the glass substrate in a step after glass forming, such as a polishing step. Thus, when the surface of the tempered glass substrate is left unpolished, the original mechanical strength is hardly impaired, and the tempered glass substrate hardly undergoes breakage. In addition, the manufacturing cost of the glass substrate can be reduced. When the entire effective surfaces of both surfaces (front surface and back surface) of the tempered glass substrate of the present invention are left unpolished, the tempered glass substrate is still less liable to undergo breakage. In addition, in order to prevent a situation in which breakage occurs from a cut surface, the cut surface maybe subjected to chamfering processing, etching treatment, or the like. It should be noted that in order to obtain the unpolished surface, it is recommended to form the glass substrate by an overflow down-draw method.

In the tempered glass substrate of the present invention, the liquidus temperature is preferably 1,200° C. or less, more preferably 1,050° C. or less, more preferably 1,030° C. or less, more preferably 1,010° C. or less, more preferably 1,000° C. or less, more preferably 950° C. or less, more preferably 900° C. or less, particularly preferably 870° C. or less. The liquidus temperature may be lowered by increasing the content of Na₂O, K₂O, or B₂O₃ or reducing the content of Al₂O₃, Li₂O, MgO, ZnO, TiO₂, or ZrO₂.

In the tempered glass substrate of the present invention, the liquidus viscosity is preferably 10^{4.0} dPa·s or more, more preferably 10^{4.3} dPa·s or more, more preferably 10^{4.5} dPa·s or more, more preferably 10^{5.0} dPa·s or more, more preferably 10^{5.4} dPa·s or more, more preferably 10^{5.8} dPa·s or more, more preferably 10^{6.0} dPa·s or more, particularly preferably 10^{6.2} dPa·s or more. The liquidus viscosity may be increased by increasing the content of Na₂O or K₂O or reducing the content of Al₂O₃, Li₂O, MgO, ZnO, TiO₂, or ZrO₂.

It should be noted that when the liquidus temperature is 1,200° C. or less and the liquidus viscosity is 10^{4.0} dPa·s or more, the tempered glass substrate can be formed by an overflow down-draw method.

In the tempered glass substrate of the present invention, the density is preferably 2.8 g/cm³ or less, more preferably 2.7 g/cm³ or less, particularly preferably 2.6 g/cm³ or less. As the density reduces, the weight of the tempered glass substrate can be reduced. Herein, the “density” refers to a value measured by a well-known Archimedes method. It should be noted that the density may be lowered by increasing the content of SiO₂, P₂O₅, or B₂O₃ or reducing the content of an alkali metal oxide, an alkaline earth metal oxide, ZnO, ZrO₂, or TiO₂.

The tempered glass substrate of the present invention has a thermal expansion coefficient in the temperature range of from 30 to 380° C. of preferably from 70 to 110×10⁻⁷/° C., more preferably from 75 to 110×10⁻⁷/° C., more preferably from 80 to 110×10⁻⁷/° C., particularly preferably from 85 to 110×10⁻⁷/° C. When the thermal expansion coefficient falls within the range, the thermal expansion coefficient can be easily matched with that of a member such as a metal or an organic adhesive, which makes it easy to prevent the detachment of the member such as the metal or the organic adhesive. Herein, the “thermal expansion coefficient” refers to a value obtained by measuring an average thermal expansion coefficient in the temperature range of from 30 to 380° C. with a dilatometer. It should be noted that the thermal expansion coefficient may be increased by increasing the content of an alkali metal oxide or an alkaline earth metal oxide, and conversely, may be lowered by reducing the content of the alkali metal oxide or the alkaline earth metal oxide.

The tempered glass substrate of the present invention has a strain point of preferably 500° C. or more, more preferably 510° C. or more, more preferably 520° C. or more, more preferably 540° C. or more, more preferably 550° C. or more, particularly preferably 560° C. or more. As the strain point increases, the heat resistance improves, and hence the compressive stress layer becomes less liable to disappear even when the tempered glass substrate is subjected to heat treatment. In addition, when the strain point is high, stress relaxation hardly occurs at the time of the ion exchange treatment, and hence a high compressive stress value can be easily obtained. The strain point may be increased by reducing the content of an alkali metal oxide or increasing the content of an alkaline earth metal oxide, Al₂O₃, ZrO₂, or P₂O₅.

The tempered glass substrate of the present invention has a temperature corresponding to 10^{2.5} dPa·s of preferably 1,650° C. or less, more preferably 1,500° C. or less, more preferably 1,450° C. or less, more preferably 1,430° C. or less, more preferably 1,420° C. or less, particularly preferably 1,400° C. or less. The temperature corresponding to 10^{2.5} dPa·s corresponds to a melting temperature. Accordingly, as the temperature corresponding to 10^{2.5} dPa·s reduces, the glass can be melted at a lower temperature. Therefore, as the temperature corresponding to 10^{2.5} dPa·s reduces, a load on glass manufacturing equipment such as a melting furnace reduces and the bubble quality of the glass substrate can be enhanced. Thus, as the temperature corresponding to 10^{2.5} dPa·s reduces, the glass substrate can be manufactured at lower cost. It should be noted that the temperature corresponding to 10^{2.5} dPa·s may be lowered by increasing the content of an alkali metal oxide, an alkaline earth metal oxide, ZnO, B₂O₃, or TiO₂ or reducing the content of SiO₂ or Al₂O₃.

The tempered glass substrate of the present invention has a Young's modulus of preferably 70 GPa or more, more preferably 73 GPa or more, particularly preferably 75 GPa or more. When the tempered glass substrate is applied to a cover glass for a display, as the Young's modulus increases, the amount of deformation upon pressing of the surface of the cover glass with a pen or a finger reduces, and hence damage to be inflicted on the internal display can be reduced.

### EXAMPLES

The present invention is hereinafter described based on Examples. It should be noted that Examples are merely illustrative. The present invention is by no means limited to Examples.

Table 1 shows the glass composition and characteristics of Examples of the present invention (Sample Nos. 1 to 4).

TABLE 1

| | | No. 1 | No. 2 | No. 3 | No. 4 |
|---|---|---|---|---|---|
| Glass | SiO₂ | 57.3 | 58.4 | 60.8 | 61.3 |
| composition | Al₂O₃ | 13.0 | 13.0 | 16.3 | 12.8 |
| (wt %) | B₂O₃ | 2.0 | 0.0 | 0.6 | 0.0 |
| | Li₂O | 0.01 | 0.1 | 0.0 | 0.0 |
| | Na₂O | 14.5 | 14.5 | 14.1 | 12.3 |
| | K₂O | 4.9 | 5.5 | 3.6 | 5.9 |
| | MgO | 2.0 | 2.0 | 3.6 | 6.5 |
| | CaO | 2.0 | 2.0 | 0.5 | 0.2 |
| | ZrO₂ | 4.0 | 4.5 | 0.0 | 1.0 |
| | SnO₂ | 0.3 | 0.0 | 0.5 | 0.0 |

| | | | | |
|---|---|---|---|---|
| Density (g/cm³) | 2.54 | 2.54 | 2.46 | 2.48 |
| Ps (° C.) | 510 | 533 | 557 | 555 |
| Ta (° C.) | 550 | 576 | 605 | 602 |
| Ts (° C.) | 750 | 793 | 846 | 826 |
| 10⁴ dPa · s (° C.) | 1,095 | 1,142 | 1,230 | 1,171 |
| 10³ dPa · s (° C.) | 1,275 | 1,319 | 1,430 | 1,354 |
| 10^{2.5} dPa · s (° C.) | 1,390 | 1,431 | 1,560 | 1,477 |
| α (×10⁻⁷/° C.) | 100 | 102 | 92 | 96 |
| TL (° C.) | 855 | 880 | 925 | 1,107 |
| logη_{TL} (dPa · s) | 6.1 | 6.4 | 6.6 | 4.5 |

Each sample shown in Table 1 was produced as described below. First, glass raw materials were blended so as to have the glass composition in the table, and the resultant glass batch was melted at 1,580° C. for 8 hours using a platinum pot. After that, the molten glass was poured onto a carbon sheet so as to be formed into a sheet shape. The resultant glass substrate was evaluated for various characteristics.

The density is a value obtained through measurement by a well-known Archimedes method.

The strain point Ps and the annealing point Ta are values obtained through measurement based on a method of ASTM C336.

The softening point Ts is a value obtained through measurement based on a method of ASTM C338.

The temperatures corresponding to 10^{4.0} dPa·s, 10^{3.0} dPa·s, and 10^{2.5} dPa·s are values obtained through measurement by a platinum sphere pull up method.

The thermal expansion coefficient α is a value obtained through measurement of an average thermal expansion coefficient in a temperature range of from 30 to 380° C. using a dilatometer.

The liquidus temperature TL is a value obtained through measurement of a temperature at which crystals of glass are deposited after glass powder that is obtained by pulverizing a glass, passes through a standard 30-mesh sieve (sieve opening: 500 μm), and remains on a 50-mesh sieve (sieve opening: 300 μm) is placed in a platinum boat and then kept for 24 hours in a gradient heating furnace.

The liquidus viscosity log ηTL refers to a viscosity of each glass at the liquidus temperature.

The results showed that the obtained glass substrate had a density of 2.54 g/cm³ or less and a thermal expansion coefficient of from 92 to 102×10⁻⁷/° C., and hence was suitable as a tempered glass material. In addition, the glass substrate has a liquidus viscosity of 10^{4.5} dPa·s or more, can be formed by an overflow down-draw method, and has a temperature at 10^{2.5} dPa·s of 1,560° C. or less. Accordingly, it is considered that the glass substrate can be supplied in a large amount at low cost.

Subsequently, Samples Nos. 1 to 4 were subjected to ion exchange treatment in a KNO₃ molten salt bath having a controlled concentration of Na ions. It should be noted that the concentration of the Na ions was adjusted by adding a predetermined amount of NaNO₃ in the KNO₃ molten salt. Next, the surface of each of the samples after the ion exchange treatment was washed, and then the compressive stress value and depth of layer of the surface were calculated on the basis of the number of interference fringes observed using a surface stress meter (FSM-6000 manufactured by TOSHIBA CORPORATION) and intervals therebetween. Table 2 shows the results. In the calculation of the compressive stress value and the depth of layer, the refractive index of each of Samples Nos. 1 to 4 was defined as 1.52 [(nm/cm)/MPa.], the optical elastic constant of Sample No. 1 was defined as 28, the optical elastic constant of Sample No. 2 was defined as 28, the optical elastic constant of Sample No. 3 was defined as 29, and the optical elastic constant of Sample No. 4 was defined as 28. It should be noted that the glass composition differs microscopically in the surface layer between the untempered glass substrate and the tempered glass substrate, but when each of the glass substrates is observed as a whole, the glass composition does not differ substantially. Thus, the untempered glass substrate and the tempered glass substrate do not differ from each other substantially in glass physical properties such as density and viscosity.

TABLE 2

| | | | No. 1 | | No. 2 | | No. 3 | | No. 4 | |
|---|---|---|---|---|---|---|---|---|---|---|
| | | | | Depth | | Depth | | Depth | | Depth |
| Tempering | Na | Tempering | Compressive | of | Compressive | of | Compressive | of | Compressive | of |
| temperature | concentration | time | stress | layer | stress | layer | stress | layer | stress | layer |
| [° C.] | [ppm] | [h] | [MPa] | [μm] | [MPa] | [μm] | [MPa] | [μm] | [MPa] | [μm] |
| 400 | 0 | 2 | 1,008 | 12 | 937 | 15 | 926 | 17 | 851 | 16 |
| | | 4 | 994 | 18 | 934 | 20 | 920 | 24 | 864 | 24 |
| | | 6 | 977 | 21 | 932 | 26 | 913 | 30 | 877 | 28 |
| | | 8 | 961 | 25 | 919 | 29 | 901 | 36 | 883 | 33 |
| | 3,000 | 2 | 886 | 13 | 803 | 17 | 847 | 18 | 713 | 18 |
| | | 4 | 886 | 19 | 805 | 21 | 801 | 24 | 760 | 24 |
| | | 6 | 867 | 22 | 815 | 26 | 794 | 30 | 770 | 30 |
| | | 8 | 862 | 24 | 818 | 30 | 790 | 35 | 783 | 32 |
| | 9,000 | 2 | 656 | 12 | 587 | 16 | 699 | 17 | 560 | 17 |
| | | 4 | 654 | 19 | 588 | 20 | 644 | 24 | 571 | 26 |
| | | 6 | 650 | 22 | 602 | 26 | 608 | 30 | 585 | 30 |
| | | 8 | 648 | 25 | 596 | 32 | 650 | 35 | 601 | 33 |
| | 12,000 | 2 | 680 | 11 | 596 | 15 | 704 | 17 | 544 | 17 |
| | | 4 | 676 | 18 | 606 | 21 | 644 | 24 | 577 | 23 |
| | | 6 | 674 | 21 | 621 | 25 | 613 | 31 | 597 | 28 |
| | | 8 | 668 | 25 | 616 | 30 | 612 | 35 | 610 | 33 |
| 420 | 0 | 2 | 932 | 20 | 885 | 23 | 875 | 27 | 835 | 24 |
| | | 4 | 907 | 28 | 870 | 31 | 857 | 36 | 837 | 33 |
| | | 6 | 885 | 33 | 860 | 37 | 843 | 45 | 838 | 40 |
| | | 8 | 867 | 38 | 845 | 43 | 827 | 52 | 830 | 46 |
| | 3,000 | 2 | 833 | 21 | 770 | 24 | 808 | 27 | 718 | 26 |
| | | 4 | 819 | 29 | 767 | 31 | 788 | 36 | 741 | 33 |
| | | 6 | 801 | 34 | 779 | 37 | 740 | 45 | 740 | 41 |
| | | 8 | 788 | 37 | 757 | 44 | 741 | 51 | 737 | 45 |
| | 9,000 | 2 | 629 | 20 | 576 | 25 | 677 | 27 | 565 | 26 |
| | | 4 | 625 | 29 | 580 | 31 | 643 | 36 | 568 | 35 |
| | | 6 | 619 | 34 | 585 | 37 | 608 | 45 | 572 | 42 |
| | | 8 | 613 | 38 | 571 | 45 | 628 | 51 | 575 | 47 |
| | 12,000 | 2 | 648 | 20 | 585 | 23 | 683 | 26 | 559 | 25 |
| | | 4 | 645 | 28 | 591 | 32 | 651 | 36 | 571 | 33 |
| | | 6 | 634 | 34 | 600 | 36 | 611 | 45 | 577 | 40 |
| | | 8 | 629 | 38 | 597 | 42 | 633 | 51 | 580 | 46 |
| 440 | 0 | 2 | 894 | 25 | 869 | 28 | 851 | 33 | 837 | 30 |
| | | 4 | 844 | 36 | 837 | 39 | 817 | 46 | 825 | 42 |
| | | 6 | 816 | 42 | 811 | 47 | 791 | 57 | 815 | 49 |
| | | 8 | 792 | 49 | 793 | 53 | 773 | 65 | 808 | 56 |
| | 3,000 | 2 | 812 | 26 | 768 | 29 | 792 | 33 | 739 | 31 |
| | | 4 | 772 | 36 | 754 | 39 | 748 | 46 | 734 | 42 |
| | | 6 | 752 | 43 | 760 | 47 | 751 | 56 | 725 | 51 |
| | | 8 | 729 | 48 | 715 | 54 | 708 | 65 | 718 | 56 |
| | 9,000 | 2 | 624 | 26 | 586 | 31 | 674 | 33 | 582 | 32 |
| | | 4 | 609 | 37 | 589 | 39 | 652 | 46 | 574 | 44 |
| | | 6 | 599 | 43 | 578 | 47 | 613 | 56 | 569 | 51 |
| | | 8 | 585 | 48 | 558 | 53 | 617 | 65 | 570 | 56 |
| | 12,000 | 2 | 640 | 27 | 594 | 30 | 681 | 32 | 586 | 31 |
| | | 4 | 626 | 35 | 594 | 41 | 646 | 46 | 574 | 43 |
| | | 6 | 606 | 43 | 591 | 47 | 614 | 56 | 569 | 49 |
| | | 8 | 598 | 48 | 589 | 52 | 618 | 64 | 571 | 56 |

As apparent from Table 2, when each of Samples Nos. 1 to 4 was immersed in a KNO₃ molten salt having an Na ion concentration of from0 to 3, 000 ppm, the compressive stress value became relatively high. Accordingly, it can be presumed that each of the samples becomes able to be used as a tempered glass substrate having high mechanical strength. In addition, when each of the samples was immersed in a KNO₃ molten salt having an Na ion concentration of from 9,000 to 12,000 ppm, the compressive stress value became moderately high. Accordingly, it can be presumed that each of the samples becomes suitable for cutting after the ion exchange treatment. Further, when each of the samples was immersed in a KNO₃ molten salt having an Na ion concentration of from 9,000 to 12,000 ppm, the compressive stress value hardly changed in association with an increase in Na ion concentration, and substantially comparable tempering characteristics were obtained for the similar ion exchange temperature and the same ion exchange time. In this case, it is considered that even if the KNO₃ molten salt is used as a tempering bath in actual production over a long period of time, a compressive stress layer suitable for cutting after the ion exchange treatment is formed.

It should be noted that in Examples, for experimental convenience, after the glass batch had been melted and formed by pouring, optical polishing was performed before the ion exchange treatment. When production is performed on an industrial scale, it is desired that: the glass substrate be produced by an overflow down-draw method or the like; and the ion exchange treatment be performed while the entire effective surfaces of both surfaces of the glass substrate are in an unpolished state.

### INDUSTRIAL APPLICABILITY

The tempered glass substrate of the present invention is suitable for a cover glass for a cellular phone, a digital camera, a PDA, a solar cell, or the like, or a substrate for a touch panel display. Further, the tempered glass substrate of the present invention can be expected to find use in applications requiring high mechanical strength, for example, a window glass, a substrate for a magnetic disk, a substrate for a flat panel display, a cover glass for a solid image pick-up element, and tableware, in addition to the above-mentioned applications.

1. A method of manufacturing a tempered glass substrate, comprising:
melting glass raw materials blended so as to have a glass composition comprising, in terms of mass %, 40 to 71% of SiO₂, 3 to 23% of Al₂O₃, 0 to 3.5% of Li₂O, 7 to 20% of Na₂O, and 0 to 15% of K₂O;
forming the resultant molten glass into a sheet shape; and
performing ion exchange treatment in a KNO₃ molten salt, the KNO₃ molten salt having a controlled concentration of Na ions, to form a compressive stress layer in a surface of the glass.

2. A method of manufacturing a tempered glass substrate, comprising:
melting glass raw materials blended so as to have a glass composition comprising, in terms of mass %, 40 to 71% of SiO₂, 3 to 23% of Al₂O₃, 0 to 3.5% of Li₂O, 7 to 20% of Na₂O, and 0 to 15% of K₂O;
forming the resultant molten glass into a sheet shape; and
performing ion exchange treatment in a KNO₃ molten salt comprising 1,000 to 50,000 ppm of Na ions to form a compressive stress layer in a surface of the glass.

3. A method of manufacturing a tempered glass substrate, comprising:
melting glass raw materials blended so as to have a glass composition comprising, in terms of mass %, 40 to 71% of SiO₂, 3 to 23% of Al₂O₃, 0 to 3.5% of Li₂O, 7 to 20% of Na₂O, and 0 to 15% of K₂O;
forming the resultant molten glass into a sheet shape; and
performing ion exchange treatment in a KNO₃ molten salt comprising one kind or two or more kinds of Na ions, Li ions, Ag ions, Ca ions, Sr ions, and Ba ions to form a compressive stress layer in a surface of the glass.

4. The method of manufacturing a tempered glass substrate according to claim 1, wherein the forming the molten glass into a sheet shape is performed by a down-draw method.

5. The method of manufacturing a tempered glass substrate according to claim 1, wherein the forming the molten glass into a sheet shape is performed by an overflow down-draw method.

6. A tempered glass substrate having a compressive stress layer in a surface thereof, comprising as a glass composition, in terms of mass %, 40 to 71% of SiO₂, 3 to 23% of Al₂O₃, 0 to 3.5% of Li₂O, 7 to 20% of Na₂O, and 0 to 15% of K₂O, and being subjected to ion exchange treatment in a KNO₃ molten salt comprising Na ions.

7. The tempered glass substrate according to claim 6, wherein the tempered glass substrate is subjected to ion exchange treatment in a KNO₃ molten salt comprising 1,000 to 50,000 ppm of Na ions.

8. The tempered glass substrate according to claim 6, wherein the compressive stress layer has a compressive stress value of 700 MPa or less and/or a depth of layer of 40 μm or less.

9. The tempered glass substrate according to claim 6, wherein the tempered glass substrate has an unpolished surface.

10. The tempered glass substrate according to claim 6, wherein the tempered glass has a liquidus temperature of 1,200° C. or less.

11. The tempered glass substrate according to claim 6, wherein the tempered glass substrate has a liquidus viscosity of 10^{4.0} dPa·s or more.

12. The tempered glass substrate according to claim 6, wherein the tempered glass substrate is used for a cover glass for a display.

13. The tempered glass substrate according to claim 6, wherein the tempered glass substrate is used for a cover glass for a solar cell.

14. A tempered glass substrate having a compressive stress layer in a surface thereof, comprising as a glass composition, in terms of mass %, 40 to 71% of SiO₂, 3 to 23% of Al₂O₃, 0 to 3.5% of Li₂O, 7 to 20% of Na₂O, and 0 to 15% of K₂O, and having an internal tensile stress value of 60 MPa or less.

15. The method of manufacturing a tempered glass substrate according to claim 2, wherein the forming the molten glass into a sheet shape is performed by a down-draw method.

16. The method of manufacturing a tempered glass substrate according to claim 3, wherein the forming the molten glass into a sheet shape is performed by a down-draw method.

17. The method of manufacturing a tempered glass substrate according to claim 2, wherein the forming the molten glass into a sheet shape is performed by an overflow down-draw method.

18. The method of manufacturing a tempered glass substrate according to claim 3, wherein the forming the molten glass into a sheet shape is performed by an overflow down-draw method.

19. The tempered glass substrate according to claim 7, wherein the compressive stress layer has a compressive stress value of 700 MPa or less and/or a depth of layer of 40 μm or less.

20. The tempered glass substrate according to claim 7, wherein the tempered glass substrate has an unpolished surface.
